(19) United States
(12) Patent Application Publication
(10) Pub. No.: US 2010/0158387 A1
(43) Pub. Date: Jun. 24, 2010

(54) SYSTEM AND METHOD FOR REAL-TIME FACE DETECTION USING STEREO VISION

(75) Inventors: Seung Min CHOI, Daejeon (KR); Jae Il Cho, Daejeon (KR); Ji Ho Chang, Daejeon (KR); Dae Hwan Hwang, Daejeon (KR); Do Hyung Kim, Daejeon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/546,169

(22) Filed: Aug. 24, 2009

(30) Foreign Application Priority Data
Dec. 22, 2008 (KR) 10-2008-0131279

(51) Int. Cl. G06K 9/46

(52) U.S. Cl. 382/195

(57) ABSTRACT

A system and a method for detecting a face are provided. The system includes a vision processing unit and a face detection unit. The vision processing unit calculates distance information using a plurality of images including a face pattern, and discriminates between a foreground image including the face pattern and a background image not including the face pattern, using the distance information. The face detection unit scales the foreground image according to the distance information, and detects the face pattern from the scaled foreground image.

### CROSS-REFERENCE TO RELATED APPLICATIONS

This application claims priority under 35 U.S.C. §119 to Korean Patent Application No. 10-2008-0131279, filed on Dec. 22, 2008, in the Korean Intellectual Property Office, the disclosure of which is incorporated herein by reference in its entirety.

### TECHNICAL FIELD

The present disclosure relates to a system and a method for detecting a face, and in particular, to a system and a method for real-time face detection using image information acquired through stereo vision in Human Robot Interaction (HRI) technology for intelligent robots.

### BACKGROUND

Generally, face recognition technology is widely used in the fields of user authentication, security systems, and Human Robot Interaction (HRI). Face recognition technology is implemented in a non-contact manner, unlike ID card technology and fingerprint recognition technology. Accordingly, face recognition technology is widely used, because users do not express reluctance or complaint of inconvenience (as opposed to a contact manner) and no additional sensor equipment is needed.

Face recognition technology requires face detection technology for pre-processing. Face detection technology is generally implemented through a process of classifying an image of a face into face patterns and non-face patterns.

Examples of related art face detection technology include the Skin Color based approach, the Support Vector Machine (SVM) approach, the Gaussian Mixture approach, the Maximum Likelihood approach, and the Neural Network approach.

The basic requirements for embodying the above technologies in hardware includes establishing a database for storing information on face patterns and non-face patterns, and establishing a look-up table for storing cost values of facial features. A cost value is a predictive value that expresses the possibility of a face existing as a numerical value, based on internally-collected statistical data. With these technologies, relatively high-quality facial detection performance may be ensured when the look-up table and the database contain great amounts of data.

However, this related art face detection technology is unable to provide real-time face detection performance due to the time required to access the look-up table, scaling of the look-up table, and excessive operations such as addition.

### SUMMARY

In one general aspect, a system for detecting a face includes: a vision processing unit calculating distance information using a plurality of images including a face pattern, and discriminating between a foreground image including the face pattern and a background image not including the face pattern, using the distance information; and a face detection unit scaling the foreground image according to the distance information, and detecting the face pattern from the scaled foreground image.

In another general aspect, a system for detecting a face includes: a vision processing unit calculating distance information using a plurality of images including a face pattern, and extracting a foreground image including the face pattern, using the distance information; an image scaling unit scaling the foreground image according to the distance information; an image rotation unit rotating the scaled foreground image by a certain angle; an image transform unit transforming the rotated foreground image into a pre-processed image; and a face detection unit calculating cost values expressing a face existence possibility as a numerical value using the pre-processed image, and detecting a face pattern from the foreground image corresponding to the pre-processed image using the cost values.

In another general aspect, a method for detecting a face includes: acquiring information on a distance from an object and a stereo matching image including a face pattern of the object; separating a foreground image including a face pattern and a background image not including a face pattern from the stereo matching image; scaling an image size of the foreground image using the distance information; rotating the scaled foreground image by a certain angle; and detecting a face pattern from the rotated foreground image.

Other features and aspects will be apparent from the following detailed description, the drawings, and the claims.

### BRIEF DESCRIPTION OF THE DRAWINGS

FIG. 1 is a flowchart illustrating an AdaBoost scheme, which is applied to an exemplary embodiment of the present invention.

FIG. 2 is a diagram illustrating an exemplary process for calculating a cost value in FIG. 1.

FIG. 3 is a block diagram illustrating a face detection system according to an exemplary embodiment of the present invention.

FIG. 4 is a block diagram illustrating an exemplary vision processing unit in FIG. 3.

FIG. 5 is a flowchart illustrating an exemplary face detection method using a face detection system in FIG. 3.

FIG. 6 is a diagram illustrating a part of an exemplary process for detecting a face pattern according to the flowchart shown in FIG. 1.

FIG. 7 is a diagram illustrating a part of an exemplary process for detecting a face pattern according to the flowchart shown in FIG. 5.

### DETAILED DESCRIPTION OF EMBODIMENTS

Hereinafter, exemplary embodiments will be described in detail with reference to the accompanying drawings. Throughout the drawings and the detailed description, unless otherwise described, the same drawing reference numerals will be understood to refer to the same elements, features, and structures. The relative size and depiction of these elements may be exaggerated for clarity, illustration, and convenience. The following detailed description is provided to assist the reader in gaining a comprehensive understanding of the methods, apparatuses, and/or systems described herein. Accordingly, various changes, modifications, and equivalents of the methods, apparatuses, and/of systems described herein will be suggested to those of ordinary skill in the art. Also, descriptions of well-known functions and constructions may be omitted for increased clarity and conciseness.

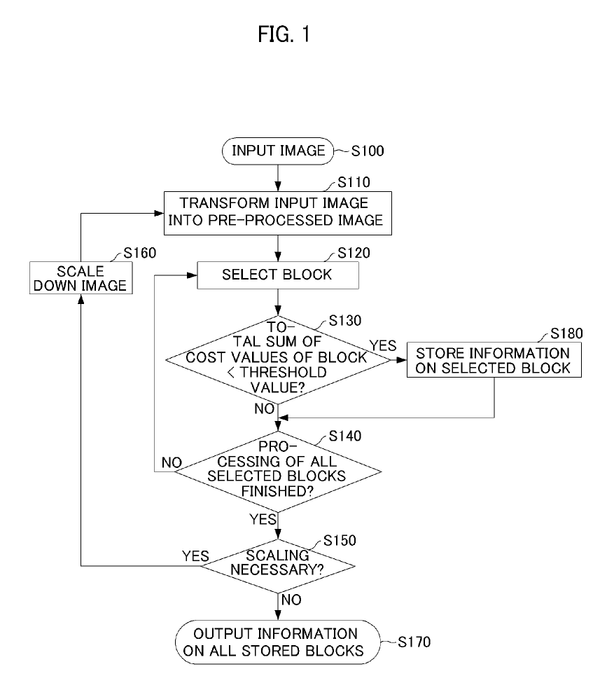

FIG. 1 is a flowchart illustrating an AdaBoost scheme, which is applied to an exemplary embodiment of the present invention.

For the purpose of explanation, the AdaBoost scheme applied to an exemplary embodiment of the present invention will be described using a specific numerical value. The resolution of the input image is assumed to be 320×240. The gradation value per each pixel is represented by data bit of 8-bit. The size of a block selected from a pre-processed image is assumed to be 20×20.

Referring to FIG. 1, the input image (or the input image frame) having 8-bit gradation value corresponding to 320 (number of rows of pixels)×240 (number of columns of pixels) size is inputted from a certain imaging device (e.g., a camera), in step S100.

The input image is transformed into a pre-processed image constituted from pre-processing coefficients in step S110. The input image is transformed into a certain image by a modeling transformation same as the face modeling transformation used in advance for making a look-up table of 20×20 image size in order to extract features of a face. That is, a gradation value of each pixel of the input image is converted into a pre-processing coefficient value.

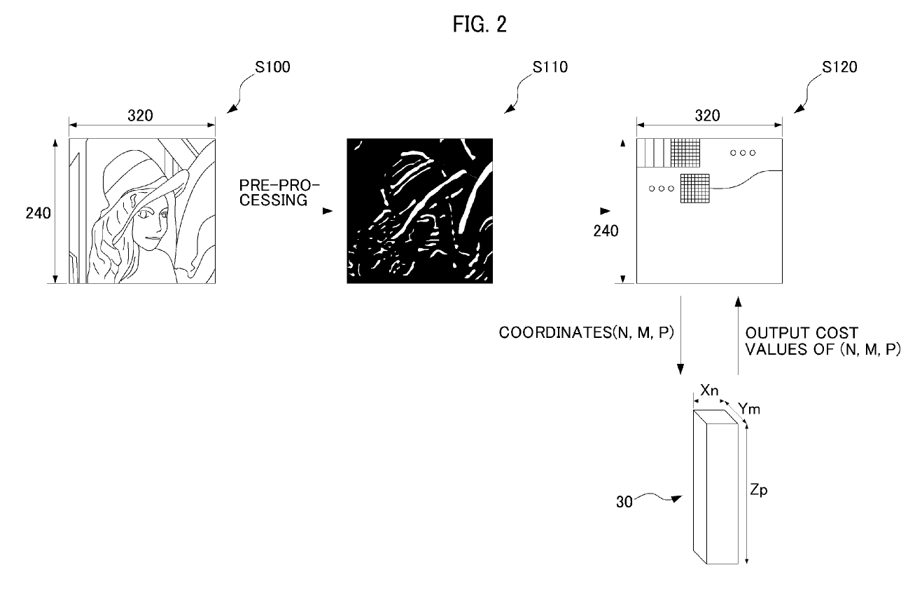

Then, the pre-processed image is divided into blocks, each of which has an image size of 20×20, from the left top of the pre-processed image in step S120. Thereafter, cost value is calculated from the pre-processing coefficients of the divided 20×20 block. Calculation of the cost values corresponding to 20×20 pre-processing coefficients is performed with reference to the 20×20 look-up table (30 in FIG. 2) storing the cost values corresponding to the pre-processing coefficients.

Next, the total sum of all cost values in the block is calculated and compared to a preset threshold value in step S130. If the total sum of the cost values is less than the threshold value, the block corresponding to the total sum of the cost values is discriminated as a face pattern, and all information on the block discriminated as the face pattern is stored in a storage medium in step S180.

Steps S110 through S140 are repeatedly performed while segmenting the pre-processed image into a block having an image size of 20×20, moving from left to right.

In order to detect a face located at a different distance from the imaging device, for example, a face having an image size of more than 20×20 pixels, it is determined if the input image acquired from the imaging device needs to be scaled in step S150. According to the result of the determination, for example, the input image is scaled down in step S160. Then, steps S120, S130, S140 and S180 are performed with respect to the scaled-down input image for the second time.

Finally, if it is determined that the image need not to be scaled, the block information on all blocks, which is stored in step S180, is outputted from the storage medium in step S170.

FIG. 2 is a diagram illustrating an exemplary process for calculating a cost value in FIG. 1.

Referring to FIG. 2, it is assumed that the resolution of the input image is 320×240, and the gradation value per each pixel is expressed by a data bit of 8-bit. The size of the block selected from the pre-processed image is assumed to be 20×20. At this time, the size of the look-up table 30 and the size of the block selected from the pre-processed image are the same. Accordingly, both the width and the length of the look-up table 30 are 20. The depth of the look-up table 30 is denoted to be Zp and the Zp is assumed to be 2⁹, i.e., 512. The depth of the look-up table 30 is defined as the number of binary trees of data bits in a unit pixel of the pre-processed image. Accordingly, the number of data bits in the unit pixel of the pre-processed image is nine in the exemplary embodiment. Xn is the abscissa of a corresponding block of the pre-processed image, and, at the same time, the abscissa of the look-up table 30. Ym is the ordinate of the corresponding block of the pre-processed image, and, at the same time, the ordinate of the look-up table 30. Zp is a coefficient value of the pre-processed image corresponding to the coordinates (Xn,Ym), and, at the same time, the depth coordinate of the look-up table 30.

An input image having a pixel resolution of Quarter Video Graphics Array (QVGA)-class (320×240) is inputted in step S100. Then, the input image is transformed into a pre-processed image through a transformation process. In this transformation process, the gradation value of 8-bit corresponding to one pixel is converted into a pre-processing coefficient value of 9-bit.

There are 66,000 (=(320−10−10)*(240−10−10)) pre-processing coefficient values (hereinafter, referred to as coefficient values) from the left top to the right bottom of the pre-processed image. Blocks of 20×20 pixels are selected based on each coefficient value in step S120. Accordingly, 400 coefficient values of 9-bit exist in each block.

Location coordinates (Xn,Ym) of coefficient value in one block, and a coefficient value of 9-bit stored in the location coordinates (Xn,Ym) are used as an address for access to the look-up table 30.

Then, one cost value corresponding to the address is outputted from the look-up table 30. Thereafter, the remaining 399 cost values in that block are outputted. 400 cost values are read from the look-up table 30 and summed up, and the total sum of the cost values is compared to the preset threshold value in step S130.

For example, when the sum of the cost values is less than the preset threshold value, the corresponding block is discriminated as a face pattern. Then, information on the corresponding block, which is discriminated as the face pattern, is stored in a storage medium in step S180.

Steps S120 and S130 are repeatedly performed for 66,000 times while moving by one pixel on the pre-processed image. If it is determined that all the blocks are processed in step S140, sizes of row and column of the input image are scaled down by k %, respectively, in step S160, if it is determined to be needed in step S150. Then, steps S110 through S140 are repeatedly performed. The k is appropriately determined in consideration of a trade-off between the face detection success rate and the operation speed.

If the size of the block becomes smaller than 20×20 by the image scaling, the scaling process is stopped. Then, coordinate values of the block stored during step S180 are outputted in step S170.

If the look-up table is elaborately designed, the face detection technology using the AdaBoost scheme shows high face detection performance of more than 90%. As described above, however, steps S120 through S140 accompanying memory access and addition operation should be repeatedly performed due to repetitive scaling down of the image. If an image of 30 frames per second is inputted, the number of commands to be operated per second may exceed several millions.

Thus, a face detection system capable of quick real-time face detection based on AdaBoost scheme, which minimizes the load of operation processing and uses the look-up table 30 efficiently, is suggested and described below.

An AdaBoost-based face detection system according to an exemplary embodiment of the present invention, as described above, detects a face by scanning an input image by 20×20 window size with reference to a look-up table (20×20 sized image equals 400 points) corresponding to face feature points (cost values).

In order to detect a face located at a different distance from an imaging device (e.g., a camera), for example, a face having an image size of more than 20×20, the face detection system scales down the input image at a scaling ratio of about 88% after the scanning of the input image, and re-scans the scaled-down input image by a window size of 20×20.

The process for scaling down the size of the input image is continued until the size of the input image reaches the size (e.g., 20×20) of the look-up table. If the size of the input image equals the size of the look-up table, the scale-down process of the image size is stopped.

High detection performance can be assured according to performance of the look-up table 30 in the embodiment of FIG. 1 using the AdaBoost scheme. However, step S160 of scaling down, and steps S120 through S140 accompanying memory access and add operation should be repeatedly performed. When an image of 30 frames per second is inputted, the number of commands to be operated exceeds several millions, which causes a deterioration of the operation speed of the system.

Hereinafter, an exemplary embodiment of a further improved face detection system capable of reducing the operation load of the system using the stereo vision device will be described.

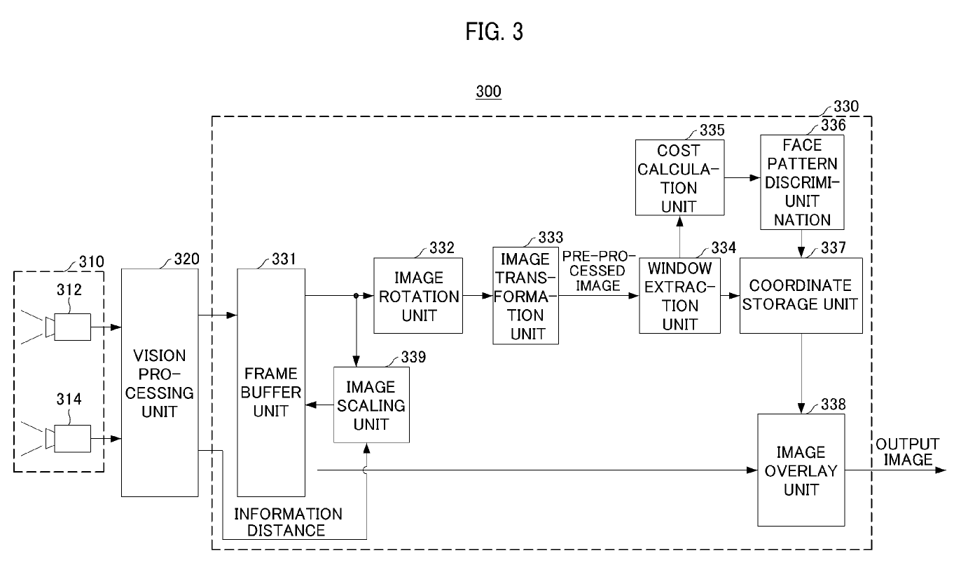

FIG. 3 is a block diagram illustrating a face detection system according to an exemplary embodiment.

Referring to FIG. 3, a face detection system 300 includes a stereo camera unit 310, a vision processing unit 320, and a face detection unit 330.

The stereo camera unit 310 includes a left camera and a right camera. The left image corresponding to the left part of the face is acquired in real-time from the left camera, and the right image corresponding to the right part of the face is acquired in real-time from the right camera. As an example, each of the right and left camera can be a CCD or CMOS camera, or a USB camera. The stereo camera unit 310 may include parallel axial cameras including two cameras 312 and 314 having optical axes parallel to each other, or intersecting axial cameras including two cameras 312 and 314 having optical axes intersecting with each other.

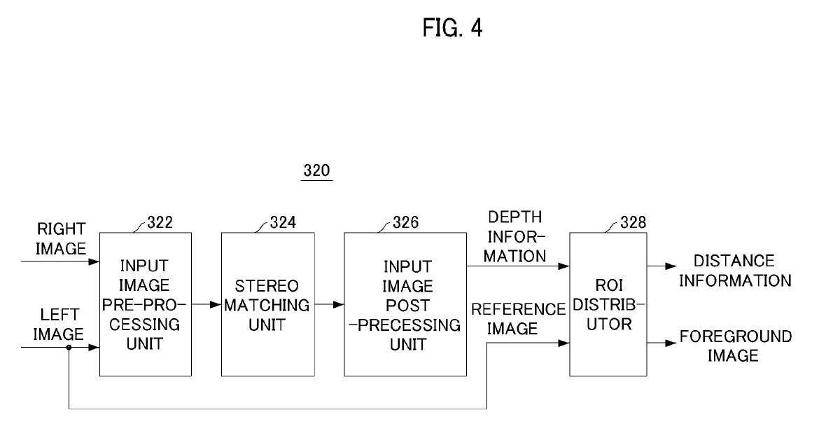

The vision processing unit 320 calculates distance information using a disparity between the left image and the right image that include a face pattern, and separates a foreground image including the face pattern from a background image not including the face pattern, based on the calculated distance information. This will be described in detail with reference to FIG. 4.

The face detection unit 330 performs a face detection task with respect to only a foreground image separated by the vision processing unit 320 according to the AdaBoost scheme. For this, the face detection unit 330 includes a frame buffer unit 331, an image rotation unit 332, an image transformation unit 333, a window extraction unit 334, a cost calculation unit 335, a face pattern discrimination unit 336, a coordinate storage unit 337, an image overlay unit 338, and an image scaling unit 339.

The frame buffer unit 331 receives a foreground image from the vision processing unit 320, and sequentially stores the foreground image by frame unit. It is assumed that the foreground image including the face pattern has 320×240 pixels, and each pixel has image data of 8-bit. Therefore, each pixel has one of gradation values of from 0 to 255.

The image rotation unit 332 receives the foreground image stored in the frame buffer unit 331 by frame unit. If the face pattern included in the foreground image is tilted, the foreground image is rotated to render the tilted face pattern upright. That is, the tilted face pattern is erected by the rotation of the foreground image in the opposite direction to the tilted direction of the face pattern. The face detection system 300 facilitates the detection of the tilted face pattern by erecting the tilted face pattern.

The image transformation unit 333 receives the foreground image rotated by the image rotation unit 332 by frame unit, and transforms the rotated foreground image into a pre-processed image robust against changes of illumination and the like. If this image transformation unit 333 transforms an image through an image transformation scheme, for example, a Modified Census Transform (MCT), the image data of 8-bit is transformed into a pre-processing coefficient value (hereinafter, an MCT coefficient value) of 9-bit that has increased by 1-bit. Accordingly, each pixel of the pre-processed image has one of MCT coefficient values of from 0 to 511.

The window extraction unit 334 scans the pre-processed image outputted from the image transformation unit 333 sequentially by a window size of 20×20, and outputs the 9-bit pre-processing coefficient values corresponding to the pre-processed image scanned by the window size of 20×20. The outputted pre-processing coefficient values are inputted into the cost calculation unit 335 having a look-up table of 20×20 size, which is pre-learned (or pre-trained).

The cost calculation unit 335 uses each pre-processing coefficient value (9-bit) of the pre-processed image of 20×20 (400 pixels) received from the window extraction unit 334 as an address to read out all the cost values corresponding to 400 pixels stored in the look-up table. Then, the cost calculation unit 335 sums up all the read-out cost values corresponding to 400 pixels, and provides the total sum of the cost values to the face pattern discrimination unit 336, as a final cost value (hereinafter, a block cost value) of a block of 20×20 window size.

The face pattern discrimination unit 336 receives the block cost value, and compares the block cost value to a preset threshold value. It is determined if the corresponding block belongs to a face pattern. For example, if the block cost value is less than the preset threshold value, the corresponding block of 20×20 window size is discriminated as a face pattern. The face pattern discrimination unit 336 detects all coordinate values existing in the corresponding block discriminated as the face pattern to store in the coordinate storage unit 337. The coordinate values stored in the coordinate storage unit 337 are provided to the image overlay unit 338.

The image overlay unit 338 receives the coordinate values from the coordinate storage unit 337 and the foreground image from the frame buffer unit 331, and outputs an output image by overlaying only the face pattern on the foreground image provided from the frame buffer unit 331 using the coordinate values.

The foreground image outputted from the frame buffer unit 331 is inputted into the image transformation unit 333 and inputted into the image scaling unit 339 as well to perform a retrieval of a face corresponding to a present image size and an image scaling at the same time.

The image scaling unit 339 scales down the foreground image by a preset scale-down ratio based on the distance information provided from the vision processing unit 320, and re-stores the scaled-down foreground image to the frame buffer unit 331.

In the face detection system 300 in FIG. 3, the scale-down ratio of the foreground image is determined according to the distance information provided from the vision processing unit 320. Unlike the embodiment of FIG. 1 where the image scaling process is repeatedly performed due to absence of the distance information between the camera and the face, the scale-down ratio of the foreground image in the embodiment of FIG. 3 is fixed according to the distance information provided from the vision processing unit 320. In the embodiment of FIG. 3, the image scaling is performed only one or two times according to the fixed scale-down ratio of the foreground image. Thus, in further improved embodiment in FIG. 3, the image scaling repetition is minimized. Accordingly, the total time taken to detect a face is substantially reduced, which improves the processing speed of the whole system 300.

Also, in the face detection system 300 in FIG. 3, the foreground image including the face pattern and the background image not including the face pattern are separated from each other, so that only the foreground image except the background image is provided to the face detection unit 330. Accordingly, the face detection task is performed with respect to only the foreground image including the face pattern in the face detection unit 330. Thus, the calculation process of the cost values, which is performed in the cost calculation unit 335, and the comparison process between the threshold value and the total sum of the cost values, which is calculated in the face pattern discrimination unit 336, are performed with respect to only the foreground image including the face pattern, which improves the operation processing speed of the cost calculation unit 335 and the face pattern discrimination unit 336 and improves the processing speed of the whole system 300 as well.

As described above, because the scale-down ratio of the image is fixed according to the distance information acquired from the vision processing unit 320 in the face detection unit 330 of FIG. 3, the whole processing time is reduced. During the reduced processing time, the image rotation unit 332 provided in the face detection unit 330 rotates the foreground image including the tilted face pattern to facilitate the face detection task of the tilted face pattern. If the foreground image does not include the tilted face pattern, the image rotation unit 332 does not need to rotate the foreground image. That is, the image rotation unit 332 receives the foreground image of the present frame from the frame buffer unit 331, and delivers the foreground image to the image transformation unit 333 without rotating the image.

FIG. 4 is a block diagram illustrating an exemplary vision processing unit in FIG. 3.

Referring to FIG. 4, a vision processing unit 320 provided in a face detection system according to an embodiment of the present invention includes an input image pre-processing unit 322, a stereo matching unit 324, an input image post-processing unit 326, and a Region of Interest (ROI) distributor 328.

The input image pre-processing unit 322 minimizes distortion of the camera through a certain image processing scheme to enhance stereo matching performance. The image processing scheme performed in the input image pre-processing unit 322 may include calibration, scale-down filtering, rectification, and brightness control. Here, the rectification refers to a process for horizontally aligning the epipolar line of the source image by applying a homography for projecting left/right images acquired from left/right cameras at different time points on an identical plane.

The stereo matching unit 324 calculates a disparity between the left and the right images that are processed in the input image pre-processing unit 322, and expresses the calculated disparity as brightness information. That is, the stereo matching unit 324 finds a stereo matching between the left and the right images to calculate a disparity map, and generates a stereo matching image based on the disparity map. In this stereo matching image, an object close to the camera unit 310 is displayed brightly, and an object far from the camera unit 310 is displayed dimly, which enables to represent the distance information of a target. For example, a foreground part including the face pattern close to the stereo camera unit 310 is displayed brightly, but a background part is displayed dimly.

The input image post-processing unit 326 calculates a depth map based on the disparity map calculated in the stereo matching unit 324, and generates a depth image according to the calculated depth map. Also, the input image post-processing unit 326 performs object segmentation for segmenting the background image and the foreground image included in the depth image. That is, the input image post-processing unit 326 groups the points having similar brightness value using the disparity map, to thereby discriminate between the foreground part including the face pattern and the background part not including the face pattern. The input image post-processing unit 326 outputs the segmented foreground and background images independently. At the same time, the input image post-processing unit 326 calculates the distance information of the foreground image and the background image, respectively. The calculated distance information of the foreground part is provided to the image scaling unit 339.

The ROI distributor 328 receives the depth image and one of the left and the right images provided from the stereo camera unit 310 as a reference image. The ROI distributor 328 designates the foreground image from the reference image as an ROI according to the depth information included in the depth image. The designated foreground image is outputted. Accordingly, blocks 331, 332, 333, 334, 335, 336, 337, 338 and 339 provided at the rear side of the ROI distributor 328 performing a face detection task perform the face detection task with respect to only the foreground image including the face pattern. Accordingly, the face detection system 300 according to the embodiment of FIG. 3 includes the above-described vision processing unit 320 to thereby perform the face detection task with respect to only the foreground image including the face pattern acquired from the vision processing unit 320. Accordingly, the window extraction unit 334 described in FIG. 3 performs the scanning process with respect to only the foreground image including the face pattern, to thereby enhance the processing speed of the whole system 300.

In the face detection system 300, the image scaling unit 339 illustrated in FIG. 3 pre-determines the scale-down ratio of the foreground image including the face pattern based on the distance information acquired from the vision processing unit 320. Accordingly, the repetition of image scaling steps S150 and S160 in FIG. 1 is minimized, thereby enhancing the processing speed of the whole system 300.

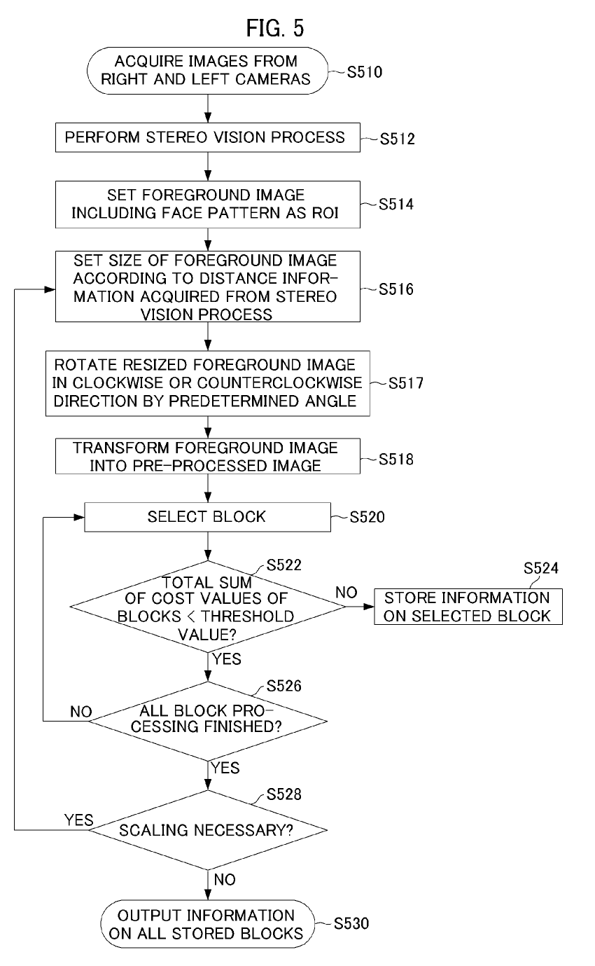

FIG. 5 is a flowchart illustrating an exemplary face detection method using a face detection system in FIG. 3. It is assumed that, in the flowchart of FIG. 5, a face detection task is performed with respect to a tilted face pattern.

Referring to FIG. 5, an input image including a left image and a right image of a face is acquired from the left and right cameras (312 and 314 in FIG. 3) of the stereo camera unit (310 in FIG. 3) in step S510.

For the stereo image including the left and right images acquired from the left and right cameras, a stereo vision processing including a pre-processing, a stereo matching, and a post-processing is performed in step S512. In the post-processing, a depth map is calculated using a disparity map generated from the stereo matching, and distance information on a foreground part and a background part is acquired from the calculated depth map.

Also, through object segmentation of the post-processing, the foreground image including a face pattern and the background image not including the face pattern are segmented using a reference image (e.g., a left image).

Then, the foreground image including the face pattern is set as an ROI in step S514 by the ROI distributor 328 (shown in FIG. 4).

Next, the foreground image is scaled down in step S516 according to the scale-down ratio calculated by the image scaling unit 339 (shown in FIG. 3) having received the calculated distance information. As described above, the scale-down ratio is determined (or fixed) according to the distance information acquired from the vision processing unit 320. Accordingly, repetition of the scale-down process of downsizing an image by phasing the scale-down ratio of the image size is significantly reduced.

If a tilted face pattern is included in the scaled-down foreground image, the scaled-down foreground image is rotated in step S517 by the image rotation unit 332 (shown in FIG. 3) in the opposite direction with respect to the tilted direction of the face pattern. If the tilted face pattern is not included in the foreground image, the image rotation of the foreground image may not be performed.

Then, the scaled-down and rotated foreground image is transformed into a pre-processed image including a pre-processing coefficient in step S518. That is, the gradation value of each pixel of the foreground image is transformed into a pre-processing coefficient value.

Next, a block of 20×20 image size is selected in step S520 from the left top of the pre-processed image corresponding to the ROI, and the cost values corresponding to the pre-processing coefficient values of segmented 20×20 blocks are calculated. Calculation of the cost values corresponding to 20×20 pre-processing coefficient values is performed by referring to the 20×20 size look-up table storing the cost values corresponding to the pre-processing coefficients.

The total sum of all cost values in one block is calculated and compared to a preset threshold value in step S522.

If the total sum of the cost values is less than the threshold value, the block corresponding to the total sum of the cost values is recognized as a face pattern, and all information on the block is stored in a storage medium in step S524.

Next, steps S520 and S522 are repeatedly performed for the entire foreground image set as a ROI by segmenting the pre-processed image into a block of 20×20 image size while moving by a pixel from left to right.

As described above, in the face detection system and the method thereof according to the exemplary embodiments described in FIGS. 3 to 5, the face detection unit 330 performs the face detection task only for the foreground image including the face pattern acquired from the vision processing unit 320. Accordingly, the calculation process of the cost values performed in the cost calculation unit 335, and the comparison process between the threshold value and the total sum of the cost values calculated in the face pattern discrimination unit 336 are performed only for the foreground image including the face pattern. Therefore, the operation processing speeds of the cost calculation unit 335 and the face pattern discrimination unit 336 are improved, thereby enhancing the processing speed of the whole system 300.

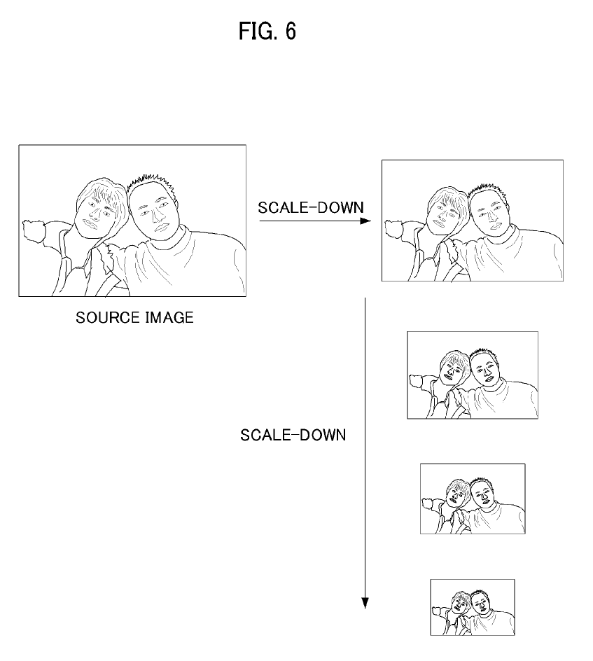

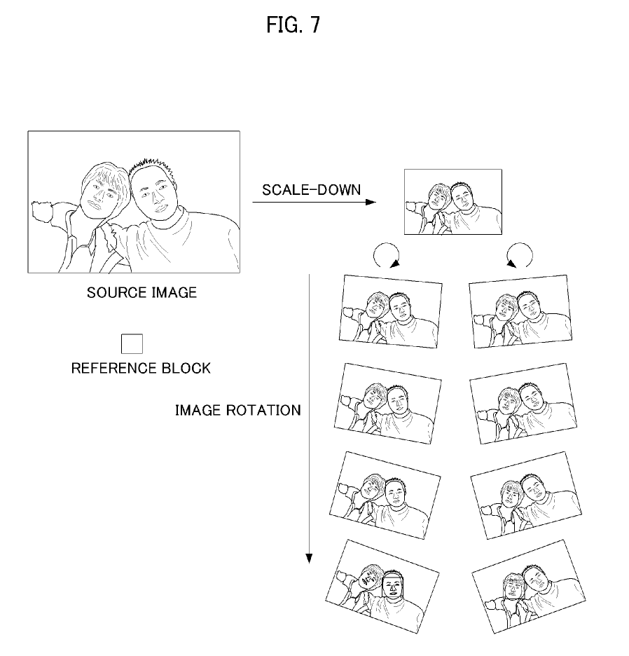

FIG. 6 is a diagram illustrating a part of an exemplary process for detecting a face pattern according to the flowchart shown in FIG. 1. FIG. 7 is a diagram illustrating a part of an exemplary process for detecting a face pattern according to the flowchart shown in FIG. 5. The source image of FIG. 6 is assumed to be an image where the foreground and the background are not separated, and the source image of FIG. 7 is assumed to be a foreground image excluding the background, which is acquired by the vision processing unit 320 (FIG. 3) according to the embodiment of the present invention. Also, processes shown in FIGS. 6 and 7 are assumed to be detecting two tilted face patterns from the source image, respectively.

As described in FIG. 6, image scale-down process is performed many times in the process of detecting a face pattern. As an example, the four-step scale-down of the source image is performed in FIG. 6, and the face pattern is detected for each step. The face pattern detected in each step is synthetically analyzed to detect a final face pattern. Accordingly, it takes much processing time to finally detect the face pattern.

On the other hand, as described in FIG. 7, the scale-down ratio of the image is determined (or fixed) according to distance information acquired from the vision processing unit 320 (FIG. 3) in the process of detecting a face pattern according to the flowchart in FIG. 5. Accordingly, the source image is scaled down by only one step or maximum of two steps, which shortens the processing time. For example, the scale-down of the source image is performed just one time in FIG. 7.

In a process of detecting a face pattern according to the flowchart in FIG. 5, in order to detect a tilted face pattern, the scaled-down foreground image is rotated by the image rotation unit 332 (FIG. 3).

Referring to FIG. 7, in order to detect the tilted face pattern which appears at the right, where the image is seen from the front, the foreground image, which is scaled down one time, is rotated clockwise over four stages. For example, the scaled-down foreground image is rotated clockwise by five degrees in each stage.

On the other hand, in order to detect the face pattern which appears at the left, the foreground image, which is scaled down one time, is rotated counterclockwise over four stages. For example, the scaled-down foreground image is rotated counterclockwise by five degrees in each stage. Accordingly, the tilted face pattern can easily be detected through the image rotation.

Thus, in the system (300 in FIG. 3) and the method for detecting a face according to the exemplary embodiments, the search region of the image for detecting a face pattern is limited to the foreground part, and therefore, the processing time of the whole system is reduced. Since the image scaling is minimized, the operation processing spare time is increased, thereby facilitating a detection of a tilted face pattern by rotating the image clockwise or counterclockwise.

If the system and the method for detecting a face according to the exemplary embodiments are put to practical use, the real-time face detection is possible for a relatively low performance system including a stereo vision device. Accordingly, the real-time face detection is possible for a portable device or a mobile robot. Furthermore, CPU load in a highly-efficient system is minimized.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A system for detecting a face, comprising:
a vision processing unit calculating distance information using a plurality of images comprising a face pattern, and discriminating between a foreground image including the face pattern and a background image not including the face pattern, using the distance information; and
a face detection unit scaling the foreground image according to the distance information, and detecting the face pattern from the scaled foreground image.

2. The system of claim 1, further comprising a stereo camera unit collecting the plurality of images comprising a right image and a left image that comprise the face pattern.

3. The system of claim 2, wherein the vision processing unit comprises:
a stereo matching unit calculating a disparity between the left image and the right image, and generating a stereo matching image expressed as a brightness information based on the disparity;
a post-processing unit calculating a depth map based on the disparity, and performing an object segmentation for discriminating the foreground image and the background image from the stereo matching image according to the depth map; and
a Region of Interest (ROI) distributor setting the foreground image as an ROI, and calculating the distance information based on the depth map.

4. The system of claim 1, wherein the face detection unit comprises:
an image scaling unit scaling the foreground image according to the distance information;
an image transformation unit transforming the scaled foreground image into a pre-processed image;
a window extraction unit scanning the pre-processed image by a preset window size, and outputting pre-processing coefficient values corresponding to the scanned pre-processed image;
a cost calculation unit calculating cost values corresponding to the pre-processing coefficient values; and
a face pattern discrimination unit discriminating the face pattern comprised in the foreground image, by comparing the total sum of the cost values with a preset threshold value.

5. A system for detecting a face, comprising:
a vision processing unit calculating distance information using a plurality of images comprising a face pattern, and extracting a foreground image including the face pattern, using the distance information;
an image scaling unit scaling the foreground image according to the distance information;
an image rotation unit rotating the scaled foreground image by a certain angle;
an image transform unit transforming the rotated foreground image into a pre-processed image; and
a face detection unit calculating cost values expressing a face existence possibility as a numerical value using the pre-processed image, and detecting a face pattern from the foreground image corresponding to the pre-processed image using the cost values.

6. The system of claim 5, wherein, if the foreground image includes a tilted face pattern, the image rotation unit rotates the foreground image at a certain angle in the opposite direction to the tilted direction of the face pattern.

7. The system of claim 6, wherein, if the foreground image includes a plurality of face patterns, the image rotation unit rotates the foreground image for each of the face patterns.

8. The system of claim 5, wherein, if the foreground image does not include a tilted foreground image, the image rotation unit provides the foreground image to the image transform unit without rotating the foreground image.

9. The system of claim 5, wherein, if the foreground image is determined to be a face pattern, the face detection unit outputs all coordinate values in the pre-processed image corresponding to the foreground image.

10. The system of claim 9, wherein the face detection unit comprises:
a frame buffer storing the foreground image extracted by the vision processing unit by frame unit;
a coordinate storage storing the coordinate value; and
an image overlay unit receiving the coordinate values stored in the coordinate storage and the foreground image stored in the frame buffer, and displaying the face pattern on the foreground image using the coordinate values.

11. A method for detecting a face, comprising:
acquiring information on a distance from an object and a stereo matching image including a face pattern of the object;
separating a foreground image including a face pattern and a background image not including a face pattern from the stereo matching image;
scaling an image size of the foreground image using the distance information;
rotating the scaled foreground image by a certain angle; and
detecting a face pattern from the rotated foreground image.

12. The method of claim 11, wherein the acquiring of a stereo matching image comprises:
acquiring a plurality of images comprising a left image and a right image, each of which has the face pattern; and
acquiring the stereo matching image by stereo-matching the left image and the right image.

13. The method of claim 12, wherein the separating of a foreground image and a background image comprises:
calculating disparity between the plurality of images;
generating a depth map using the disparity to discriminate the foreground image and the background image from the depth map; and
setting the discriminated foreground image as a region of interest to calculating the distance information from the depth map.

14. The method of claim 11, wherein the rotating of a foreground image comprises:
receiving the foreground image including a tilted face pattern; and
rotating the foreground image by a certain angle in the opposite direction to a tilted direction of the face pattern.

15. The method of claim 13, wherein the detecting of a face pattern comprises:
transforming the rotated foreground image into a pre-processed image;
scanning the pre-processed image by a preset window size to calculate pre-processing coefficient values corresponding to the scanned pre-processed image;
calculating cost values corresponding to the pre-processing coefficient values to sum up the cost values; and
comparing the total sum of the cost values with a preset threshold value to determine if the foreground image corresponding to the window size is the face pattern according to the comparison result.
